(19) United States
(12) Patent Application Publication
(10) Pub. No.: US 2024/0042634 A1
(43) Pub. Date: Feb. 8, 2024

(54) CONNECTOR FOR CONNECTING A RAZOR HEAD TO A RAZOR HANDLE

(71) Applicant: BIC Violex Single Member S.A., Anoixi (GR)

(72) Inventors: Ioannis BAGOURDAS, Anoixi (FR); Jesper BREHMER, Anoixi (FR)

(73) Assignee: BIC Violex Single Member S.A., Anoixi (GR)

(21) Appl. No.: 18/257,228

(22) PCT Filed: Nov. 22, 2021
(86) PCT No.: PCT/EP2021/082512

§ 371 Date: Jun. 13, 2023

(30) Foreign Application Priority Data
Dec. 14, 2020 (EP) 20213864.0

(51) Int. Cl. B26B 21/52

(52) U.S. Cl. CPC B26B 21/521

(57) ABSTRACT

A connector for connecting a razor head to a razor handle comprises a body portion and a connector portion. The connector portion extends from the body portion and is configured to be coupled to the razor handle. The connector portion comprises an expanding and/or contracting mechanism.

This application claims benefit from European patent application EP20213864.0, filed on 14 Dec. 2020, its content being incorporated herein by reference.

### TECHNICAL FIELD

The present disclosure relates to a connector for connecting a razor head to a razor handle, to a kit of parts and a razor comprising the connector, and to a method of connecting a razor head to a razor handle.

### BACKGROUND

Razors (also known as safety razors) have a razor head that is permanently or removably attached to a razor handle which, in use, is oriented in shaving direction. Razor heads typically comprise one or more cutting members, each supporting a blade, mounted perpendicular to the shaving direction. Razor heads are also typically provided with a guard (at a leading longitudinal side of the razor head in the shaving direction) and a cap (at a trailing longitudinal side of the razor head in the shaving direction). In use, a user holds the razor handle in the shaving direction and brings the razor head into contact with a portion of skin defining a shaving plane.

In the field of razors, there are various razor models available on the market wherein the razor handles and/or razor heads differ in shape, features, aesthetics, color and/or material. On the one hand, there are razors having a razor head permanently attached to the razor handle, which may be disposed of when the razor blades are worn out. On the other hand, there are razors wherein the razor head is removably attached to the razor handle such that, when the razor blades are worn out, the razor head can be decoupled, disposed of, and replaced by a new razor head. The state of the art discloses various connection mechanisms for such razors, including snap-fit, threaded or magnetic connections. When a razor head is removably attached to a razor handle of a specific razor model, it may not be connectable to a razor handle of a different razor model. However, it would be desirable to be able to connect a razor head with different razor handles.

The object of the present disclosure is to provide a connector for connecting a razor head to a razor handle, which is suitable to connect a razor head to different razor handles.

### SUMMARY

The present disclosure relates to a connector for connecting a razor head to a razor handle as defined in claim 1, a kit of parts as defined in claim 12, a razor as defined in claim 13 and a method of assembling a razor as defined in claim 15. The dependent claims depict advantageous embodiments of the present disclosure.

According to a first aspect of the present disclosure, a connector for connecting a razor head to a razor handle comprises a body portion and a connector portion, which extends from the body portion. The connector portion is configured to be coupled to the razor handle and comprises an expanding and/or contracting mechanism. Since the connector portion comprises an expanding and/or contracting mechanism, a razor head can be assembled to razor handles of any suitable shape, features, aesthetics, color and/or material in a secure and robust way. The connector may lead to less engineering complexity. Furthermore, tight tolerances and dimensional limitations of different razor handle materials may play no part since the expanding and/or contracting mechanism is utilized for the expansion and/or contraction of the connector portion.

The expanding and/or contracting mechanism is configured to couple the connector to the razor handle by a non-positively locking connection. In examples, the expanding and/or contracting mechanism may be configured to couple the connector to the razor handle by a friction-locking connection.

The connector may comprise a longitudinal axis, wherein the expanding and/or contracting mechanism can be adapted to expand and/or contract in a radial direction perpendicular to the longitudinal axis.

The connector portion may comprise a length, a diameter and an outer circumferential surface. The length may be between 10 mm to 70 mm, more specifically between 15 mm to 60 mm, in particular between 20 mm to 50 mm. The diameter may be between 0.5 mm to 20 mm, more specifically between 3 mm to 15 mm, in particular between 5 mm to 12 mm.

The connector portion can comprise a conical shape over the length, extending from the diameter proximate the body portion to a diameter at an end face of the connector portion. The diameter proximate to the body portion can be larger than the diameter at the end face of the connector portion.

In embodiments, the connector portion can comprise at least one recess. The at least one recess can comprise a longitudinal shape extending substantially in the direction of the longitudinal axis.

The expanding and/or contracting mechanism can comprise at least one elastic component, more specifically an elastic friction component. In an embodiment, the at least one elastic component can be arranged in the at least one recess. Alternatively or in addition, the at least one elastic component can be provided as sleeve and disposed about the connector portion. The at least one elastic component can be configured to expand and/or contract in the radial direction.

The at least one elastic component can comprise a polymeric material, more specifically wherein the at least one elastic component may comprise a shore hardness of 10 A to 60 A, in particular of 20 A to 50 A.

The at least one elastic component, when inserted into the at least one recess, can extend in the radial direction beyond the outer circumferential surface by a distance of at least 0.05 mm, more specifically by at least 0.10 mm, in particular by at least 0.30 mm.

The at least one elastic component may comprise a length and a width. More specifically, the at least one elastic component may comprise an upper face and a lower face, wherein the upper face and/or the lower face has the length and the width. The length can be between 1 mm to 20 mm, more specifically between 2 mm to 15 mm. An increased length of the at least one elastic component can lead to a larger contact surface when coupled to a razor handle, thus increasing friction-force between the respective components/surfaces. The width can be between 0.2 mm to 15 mm, more specifically between 1 mm to 10 mm.

In an embodiment, the connector portion can comprise a first recess and a second recess, more specifically wherein the first recess and the second recess are aligned to each other on the outer circumferential surface in the direction of the longitudinal axis. The expanding and/or contracting mechanism can comprise a first elastic component and a second elastic component, wherein the first elastic component can be arranged in the first recess and wherein the second elastic component can be arranged in the second recess.

The at least one recess can extend in the radial direction through the whole diameter of the connector portion. When the at least one elastic component is arranged in the at least one recess that extends through the whole diameter, pressure can be equally distributed when coupled to the razor handle.

The at least one elastic component can comprise a diameter that is larger than the diameter of the connector portion, more specifically wherein the diameter of the at least one elastic component can be at least 1.1 times larger than the diameter of the connector portion, in particular wherein the diameter of the at least one elastic component can be at least 1.2 times larger than the diameter of the connector portion.

A cross-section of the at least one elastic component can taper from the upper face and/or lower face towards a geometric center of the at least one elastic component, more specifically wherein the at least one elastic component may taper at an angle of from 90°<γ<135°, more specifically of from 105°<γ<120°, measured between the upper face and/or the lower face and the taper of the at least one elastic element.

The at least one recess can comprise a complementary shape with respect to the shape of the at least one elastic component, more specifically wherein the cross-section of the at least one recess can taper from the outer circumferential surface in the radial direction towards the longitudinal axis on each side.

The connector portion can comprise an opening extending from the body portion at least partially in the direction of the longitudinal axis towards an end face of the connector portion.

The opening may comprise a conical shape having a diameter at the body portion and a diameter proximate the end face, wherein the diameter at the body portion is larger than the diameter proximate the end face.

The body portion can comprise a body portion cavity. The opening may open into the body portion cavity.

The expanding and/or contracting mechanism can comprise a dilator component which is configured to be inserted into the opening, more specifically wherein the dilator component can be inserted into the opening through the body portion cavity. In embodiments, the dilator component can be slidably inserted into the opening. Alternatively or in addition, the dilator component may be screwed into the opening, more specifically wherein the opening may comprise an internal thread and wherein the dilator component may comprise an external thread.

The expanding and/or contracting mechanism can be formed by the connector portion and the dilator component, wherein the expanding and/or contracting mechanism can be in an expanded state when the dilator component is inserted into the opening and/or is proximate the end face, and/or, wherein the expanding and/or contracting mechanism can be in a contracted state when the dilator component is removed from the opening and/or is proximate the body portion cavity.

In the expanded state, the expanding and/or contracting mechanism can be expanded in the radial direction, and in the contracted state, the expanding and/or contracting mechanism can be contracted in the radial direction.

The connector portion can comprise at least one slot extending along the longitudinal axis at least partially over the length of the connector portion, more specifically wherein the at least one slot can extend between opening and outer circumferential surface in the radial direction. In embodiments, the connector portion can comprise two slots extending along the longitudinal axis at least partially over the length of the connector portion, wherein the two slots can be separated by an angle that is measured between the slots on the outer circumferential surface, more specifically wherein α=180°.

The connector portion can comprise at least two segments extending in the longitudinal direction, more specifically wherein the at least two segments can be at least partially separated to each other by at least one slot. In an embodiment, the connector portion can comprise three segments, more specifically wherein each segment may extend over a circumferential area of about 110°<β<130°. In another embodiment, the connector portion may comprise four segments, more specifically wherein each segment can be arranged over a circumferential area of about 80°<β<100°.

In the contracted state, the at least two segments can be adapted to at least partially contact each other and/or wherein in the expanded state, the at least two segments can be separated to each other by the at least one slot.

In embodiments, the connector can further comprise a retention and/or release mechanism connected to the body portion, which can be configured to be coupled to a razor head, more specifically wherein the retention and/or release mechanism can be connected to the body portion on a side opposite the connector portion. The retention and/or release mechanism can be integrally connected to the body portion. In examples, the retention and/or release mechanism can be formed as a separate component and connectable to the body portion by a positively locking and/or non-positively locking connection.

The connector can be manufactured by die-casting and/or moulding, and/or the at least one elastic component can be manufactured by casting and/or injection moulding.

According to a second aspect of the present disclosure, a kit of parts is provided that comprises a razor head holder comprising a plurality of razor heads and a connector (10) according to any one of the above described embodiments. In an embodiment, the kit of parts can further comprise a razor handle.

According to a third aspect of the present disclosure, a razor is provided that comprises a razor handle, a razor head, and a connector as described above. The connector is coupled to the razor handle and/or to the razor head. The connector comprising the connector portion and the expanding and/or contracting mechanism can compensate for tolerances between razor handle and connector.

The razor handle can comprise a tubular body portion having a cavity with an inner surface, an inner diameter and a length, wherein the connector portion can be inserted into the tubular body portion. The expanding and/or contracting mechanism can expand in order to increase the diameter of the connector portion and/or to compensate for tolerances between the respective components.

The expanding and/or contracting mechanism can apply a force in the radial direction against the inner surface of the tubular body portion, more specifically wherein the connector portion is coupled to the razor handle by a non-positively locking connection. In examples, the connector portion may be coupled to the razor handle by a press-fit connection. The expanding and/or contracting mechanism may apply a force of at least 0.5 N, more specifically of at least 3 N, in particular of at least 5 N in the radial direction.

According to a fourth aspect of the present disclosure, a method of assembling a razor is provided that comprises providing a razor handle, and a connector as described above, inserting the connector portion into the razor handle, and coupling the connector to the razor handle via the connector portion and the expanding and/or contracting mechanism.

In embodiments, coupling the connector to the razor handle can comprise expanding the expanding and/or contracting mechanism in the radial direction and applying a force in the radial direction against an inner surface of a cavity of the razor handle.

In an embodiment, the method may further comprise providing a razor head and coupling the connector to the razor head.

### BRIEF DESCRIPTION OF THE DRAWINGS

Other characteristics will be apparent from the accompanying drawings, which form a part of this disclosure. The drawings are intended to further explain the present disclosure and to enable a person skilled in the art to practice it. However, the drawings are intended as non-limiting examples. Common reference numerals on different figures indicate like or similar features.

FIGS. 1A to 1C are schematic views of a razor and a connector for connecting a razor head to a razor handle;

FIGS. 2A to 2F are more detailed schematic views of the connector according to a first embodiment;

FIGS. 3A to 3C are schematic cutaway side views of the connector coupled to a razor handle according to the first embodiment;

FIGS. 4A to 4C are schematic views of the connector according to a second embodiment;

FIGS. 5A and 5C are schematic views of the connector according to a third embodiment;

FIGS. 6A to 6D are schematic cutaway views of the connector according to the third embodiment;

FIGS. 7A to 7E are schematic views of the connector according to the second embodiment;

FIGS. 8A to 8C are schematic cutaway side views of the connector coupled to the razor handle according to the second embodiment.

### DETAILED DESCRIPTION

Embodiments of the connector, the kit of parts, the razor and the method of assembling a razor according to the present disclosure will be described in reference to the drawings as follows.

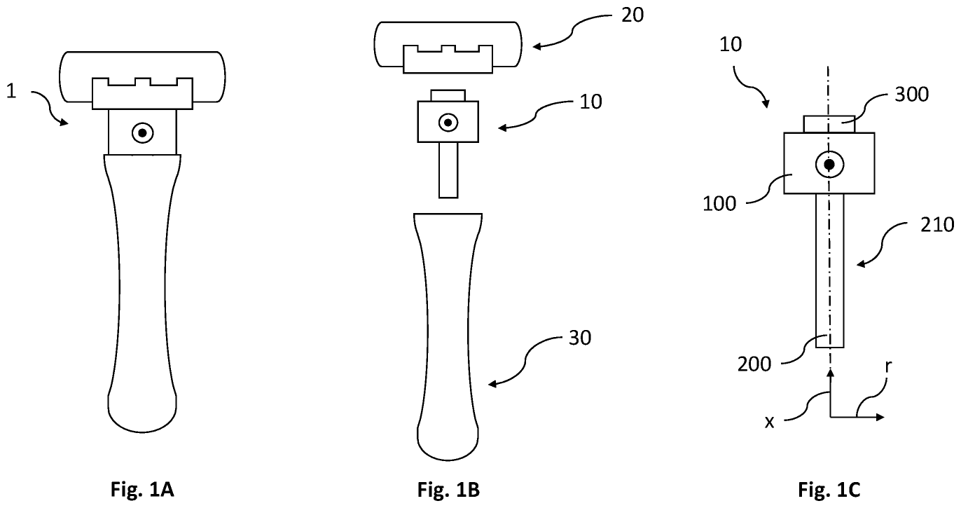

FIGS. 1A to 1C are schematic views of a razor 1 and a connector 10 for connecting a razor head 20 to a razor handle 30 according to the present disclosure. The razor 1 comprises a razor handle 30, a razor head 20 and a connector 10. The connector 10 can be coupled to the razor handle 30 and/or to the razor head 20. In embodiments, the razor head 20 can be releasably attached to the connector 10 via a pivotable or non-pivotable coupling. In other embodiments, the razor head 20 is fixedly attached to the connector 10 via a pivotable or non-pivotable coupling. As shown, e.g. in FIG. 1B, the connector 10 can be releasably coupled to the razor handle 30 and/or to the razor head 20.

Referring to FIG. 1C, the connector 10 comprises a body portion 100 and a connector portion 200 extending from the body portion 100. The connector portion 200 is configured to be coupled to the razor handle 30. The connector portion 200 comprises an expanding and/or contracting mechanism 210. Since the connector 10 comprises an expanding and/or contracting mechanism 210, a razor head 20 can be assembled to razor handles 30 of any suitable shape, features, aesthetics, color and/or material in a secure and robust way. The connector 10 leads to less engineering complexity. Furthermore, tight tolerances and dimensional limitations of different razor handle materials play no part since the expanding and/or contracting mechanism 210 can be utilized for the expansion and/or contraction of the connector portion 200. In other words, the expanding and/or contracting mechanism 210 can compensate for tolerances between razor handle 30 and connector 10, more specifically between razor handle 30 and connector portion 200. However, apart from the respective geometries, the following factors can have an influence on the tolerance requirements: material (including individual material characteristics of the assembled razor handle), precision, quality and environmental conditions of manufacturing, age and/or transportation of parts before assembly. In embodiments, the body portion 100 can be cylindrical or can have an oval, spheric, rectangular or polygonal shape (or cross-section). In embodiments, the body portion 100 can have an asymmetric shape (or cross-section). The connector portion 200 can be integrally formed with the body portion 100 or can be connected to the body portion 100 by positively locking, non-positively locking and/or adhesive bond. The connector portion 200 can be connected to a first body portion end face 102.

As shown in FIG. 1C, the connector 10 comprises a longitudinal axis x, which extends in the longitudinal direction of the connector 10 and through the geometric center of the connector 10. Furthermore, the connector 10 comprises a radial direction r, which is perpendicular to the longitudinal direction x. Furthermore, the connector 10 comprises a retention and/or release mechanism 300 connected to the body portion 100, which is configured to be coupled to the razor head 20. The retention and/or release mechanism 300 is connected to the body portion 100 on a side opposite the connector portion 200. In embodiments, the retention and/or release mechanism 300 can be integrally connected to the body portion 100. In examples, the retention and/or release mechanism 300 can be formed as a separate component and can be connected to the body portion 100 by a positively locking and/or non-positively locking connection.

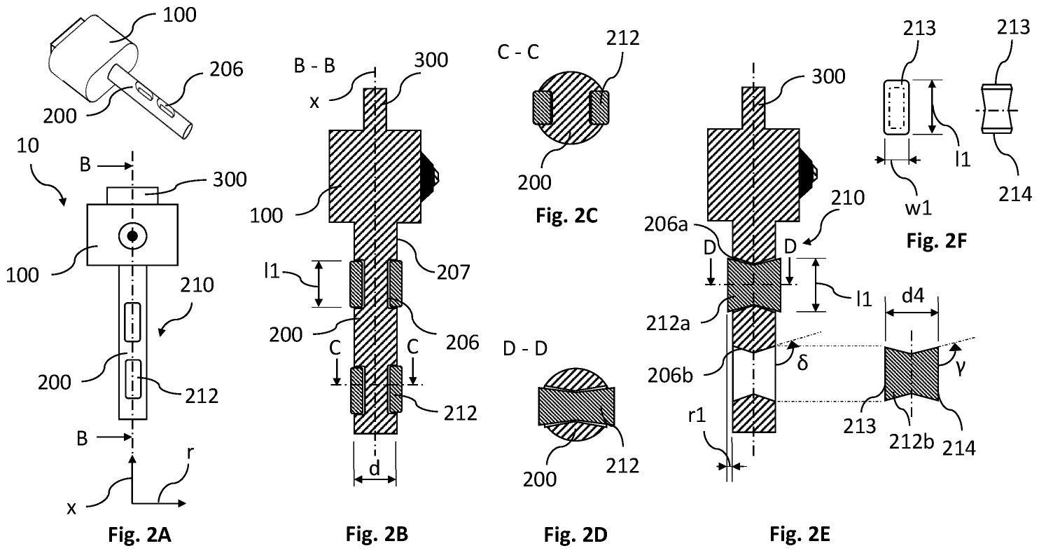

FIGS. 2A to 2F are more detailed schematic views of the connector 10 according to a first embodiment. The connector portion 200 comprises a length 1, a diameter d and an outer circumferential surface 207. More specifically, the connector portion 200 is cylindrical. However, in embodiments, the connector portion 200 may have a square-like or rectangular shape (or cross-section). In this case, the connector portion may have a cross-section having a width and a thickness instead of diameter d. The length 1 may be between 10 mm to 70 mm, more specifically between 15 mm to 60 mm, in particular between 20 mm to 50 mm. The diameter d may be between 0.5 mm to 20 mm, more specifically between 3 mm to 15 mm, in particular between 5 mm to 12 mm.

The connector portion 200 comprises at least one recess 206. The at least one recess 206 can extend from the outer circumferential surface 207 in the connector portion 200 in the radial direction r. The at least one recess 206 comprises a longitudinal shape extending substantially in the direction of the longitudinal axis x. The expanding and/or contracting mechanism 210 comprises at least one elastic component 212, more specifically an elastic friction component 212. When in contact with another component or surface, the elastic component may provide increased friction force between the respective components. The at least one elastic component 212 comprise a polymeric material having a shore hardness of 10 A to 60 A, in particular of 20 A to 50 A. The polymeric material may be an elastomer, a thermoplastic elastomer (TPE), rubber (synthetic or natural) or silicone. In embodiments, the polymeric material may be combined with additives. Amongst others, the additives may include one or more of plasticizers, oily compounds that improve rheological properties, fillers that improve mechanical properties and reduce costs, stabilizers that prevent certain chemical reactions, antistatic agents and/or colorants. The at least one elastic component may be a material that can be expanded and/or contracted and is capable of regaining its original shape when the expanding and/or contraction force is no longer applied. In embodiments, the connector 10 can be manufactured by die-casting and/or moulding, and/or the at least one elastic component 212 can be manufactured by casting and/or injection moulding. In embodiments, the at least one elastic component 212 can be manufactured by extrusion, blow moulding, injection moulding, compacting/compaction, punching, plate pressing, rolling, calendering and/or die casting.

Referring to FIGS. 2A to 2F, the at least one elastic component 212 is arranged in the at least one recess 206. As shown in FIGS. 2A to 2C, the at least one recess 206 has a width, a length and a depth. The at least one recess 206 is adapted to receive the at least one elastic component 212. In other words, the at least one recess 206 may have a complementary shape with respect to the shape of the at least one elastic component 212. In embodiments (not shown in FIGS. 2A to 2F), the at least one recess 206 can be in the form of a circumferential groove on the outer circumferential surface 207 of the connector portion 200. In this case, the at least one elastic component 212 may have a tubular shape and the at least one recess 206 may have a complementary shape to receive the at least one elastic component 212. In examples, the at least one elastic component 212 can be provided as a sleeve that is disposed about the connector portion 200. The connector portion 200 can be connected to the sleeve by an adhesive bond and/or by a press-fit connection. In this case, it may not be necessary to provide a recess 212 and/or groove on the outer circumferential surface 207 of the connector portion 200. The at least one elastic component 212 is configured to expand and/or contract in the radial direction r as will be described in more detail below. The at least one recess 206 may comprise a complementary shape with respect to the shape of the at least one elastic component 212.

As shown in FIGS. 2B to 2F, the at least one elastic component 212, when inserted into the at least one recess 206, extends in the radial direction r beyond the outer circumferential surface 207 by a distance r1 of at least 0.05 mm, more specifically by at least 0.10 mm, in particular by at least 0.30 mm. The at least one elastic component 212 comprises a length l1, which can be between 1 mm to 20 mm, more specifically between 2 mm to 15 mm. Furthermore, the at least one elastic component 212 comprises a width w1, which can be between 0.2 mm to 15 mm, more specifically between 1 mm to 10 mm. An increased length l1 and/or width w1 of the at least one elastic component 212 may lead to a larger contact surface when coupled to the razor handle 30, thus increasing friction-force between the respective components/surfaces. The at least one elastic component 212 comprises an upper face 213 and a lower face 214, wherein the upper face 213 and/or the lower face 214 have the length l1 and the width w1.

FIGS. 2B and 2C show an embodiment, wherein four recesses 206 are provided on the outer circumferential surface 207. In each case, two recesses 206 are arranged opposite each other on the outer circumferential surface 207, or in other words, separated by 180° measured in a cross-section in a circumferential direction with respect to the longitudinal axis x between the centers of the respective recesses. The respective other two recesses 206 are separated in the direction of the longitudinal axis x. The recesses 206 are aligned to each other on the outer circumferential surface 207 in the direction of the longitudinal axis x. The four recesses 206 are adapted to receive an elastic component 212, respectively. Thus, the four elastic components 212 are separated in the circumferential direction by 180° and separated (but aligned to each other) in the longitudinal direction x. In embodiments, the expanding and/or contracting mechanism 210 may comprise a plurality of elastic components 212 arranged in respective recesses 206 of the connector portion 200. The elastic components 212 may be arranged on opposite sides of the connector portion 200 with respect to the circumferential direction or may be arranged on the outer circumferential surface 207 at different angles in the circumferential direction. In examples, the recesses 206 may, when separated to each other in the longitudinal direction x, not be aligned to each other.

FIGS. 2D and 2E show another embodiment, wherein the at least one recess 206 extends in the radial direction r through the whole diameter d of the connector portion 200. The connector portion 200 comprises a first recess 206a and a second recess 206b, more specifically wherein the first recess 206a and the second recess 206b are aligned to each other on the outer circumferential surface 207 in the direction of the longitudinal axis x. In this case the expanding and/or contracting mechanism 210 comprises a first elastic component 212a and a second elastic component 212b, wherein the first elastic component 212a is arranged in the first recess 206a and wherein the second elastic component 212b is arranged in the second recess 206b. The at least one elastic component 212 comprises a diameter d4 that is larger than the diameter d of the connector portion 200. In embodiments, the diameter d4 can be at least 1.1 times larger than the diameter d. In particular, the diameter d4 can be at least 1.2 times larger than the diameter d. In case the connector 10 is coupled to the razor handle 30, the at least one elastic component 212 is pressed against an inner surface 32 of cavity of a tubular body portion 31 of the razor handle 30, as will be described in more detail below. When the at least one recess 206 extends through the whole diameter d of the connector portion 200, the at least one elastic component 212 can be pressed against the inner surface 32 on both sides. This allows the pressure to be equally distributed on the material of the razor handle 30. The at least one elastic component 212 can have a longitudinal shape wherein increased friction force can be provided.

Referring to FIGS. 2E and 2F the at least one elastic component 212 has a cross-section that tapers from the upper face 213 and/or lower face 214 towards a geometric center of the at least one elastic component 212. The at least one elastic component 212 may taper at an angle γ of from 90°<γ<135°, more specifically of from 105°<γ<120°, measured between the upper face 213 and/or the lower face 214 and the taper of the at least one elastic element 212. In other words, the at least one elastic component 212 may have an opposing wedge shape. The at least one recess may have a complementary shape. Thus, the at least one elastic component 212 can be retained in place when inserted into the at least one recess 206 extending through the whole diameter d. The at least one elastic component 212 may comprise a plane which is parallel to the upper and/or lower faces 213, 214 and extends through the geometric center of the at least one elastic component 212. The cross-section of the at least one elastic component 212 which lies in the plane may comprise a width of 0.2 mm to 15 mm, more specifically of 1 to 10 mm.

As shown in FIG. 2E, the at least one recess 206 comprises a complementary shape with respect to the shape of the at least one elastic component 212. The cross-section of the at least one recess 206 tapers from the outer circumferential surface 207 in the radial direction r towards the longitudinal axis x on each side. The at least one recess 206 comprises a taper angle δ which is measured between the outer circumferential surface 207 and the wall of the tapered portion. The taper angle δ may be equal to or larger than the angle γ. Due to the taper that extends between longitudinal axis x and outer circumferential surface 207, the at least one elastic component 212 can be held in place by a positively locking connection. The connector 10 can be manufactured by die cast or injection molding. The at least one recess 206 can be made directly by the opening directions of the mould. Furthermore, the taper angle may be optimized to use the mould's angles. Thereby, the mould operations can be simplified.

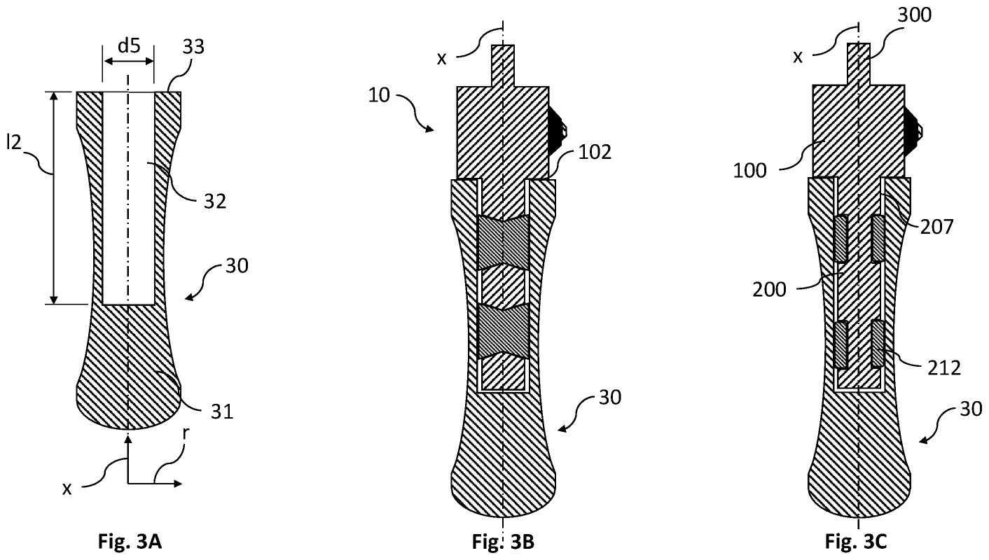

FIGS. 3A to 3C are schematic cutaway side views of the razor handle 30 and the connector 30 coupled to the razor handle 30 according to the first embodiment as described above. As shown in FIG. 3A, the razor handle 30 comprises a tubular body portion 31 having a cavity with an inner surface 32, an inner diameter d5 and a length 12. The connector portion 200 of the connector 10 can be inserted into the tubular body portion 31. The inner diameter d5 may be larger than the diameter d of the connector portion 200 such that the connector portion 200 can be inserted into the tubular body portion. The expanding and/or contracting mechanism 210 is configured to couple the connector 10 to the razor handle 30 by a non-positively locking connection, more specifically by a press-fit connection, in particular by a friction locking connection. The expanding and/or contracting mechanism 210 is adapted to expand and/or contract in the radial direction r perpendicular to the longitudinal axis x. As shown in FIGS. 3B and 3C, the expanding and/or contracting mechanism 210 applies a force in the radial direction r against the inner surface 32 of the tubular body portion 31. In an embodiment, the expanding and/or contracting mechanism 210 may apply a force of at least 0.5 N, more specifically of at least 3 N, in particular of at least 5 N, in the radial direction r. The connector portion 200 may be coupled to the razor handle 30 by a press-fit connection. A non-positively locking connection means that a normal force is applied on the surfaces to be coupled. Their mutual displacement is prevented as long as the counterforce caused by static friction is not exceeded. In other words, the surfaces of a non-positively locking connection only slip with respect to each other when a tangential force is greater than the static friction force occurring between the surfaces. In the present case, the tangential force can be regarded as a force extending in the direction of the longitudinal axis x. In embodiments, the length 12 may be larger than the length 1 such that the first body portion end face 102 mates against a razor handle end face 33 when the connector is coupled to the razor handle. In other words, the first body portion end face 102 and the razor handle end face 33 may function as end collars forming a stop.

When inserted into the tubular body portion 200 as shown in FIGS. 3B and 3C, the expanding and/or contracting mechanism can expand in the radial direction r in order to increase an effective diameter and/or to compensate for tolerances between the respective components. According to the first embodiment, the expanding and/or contracting mechanism comprises the at least one elastic component 212 which extends beyond the outer circumferential surface 207. Thereby, an outer diameter of the at least one elastic component 212 (see, e.g., d4) or a diameter measured between the connector portion 200 and an outer face of the at least one elastic component 212 in the radial direction r may be larger then the inner diameter d5 of the tubular body portion 31. In order to insert the connector portion 200 into the tubular body portion 31, the expanding and/or contracting mechanism, more specifically the at least one elastic component 212, can be contracted by the inner surface 32. As described above, the at least one elastic component 212 can be a polymeric material which is capable of regaining its original shape when contracted. Thus, when inserted into the tubular body portion 31, the expanding and/or contracting mechanism 210 expands in the radial direction r and applies force against the inner surface 32, resulting in a coupling of connector portion 200 and razor handle 30. Increasing the contact surfaces of the at least one elastic component 212 and the inner surface 31, e.g., by providing a plurality of elastic components 212 and/or increasing the length and/or the width of the elastic component(s) 212, may lead to increased friction force and thus to a more stable coupling.

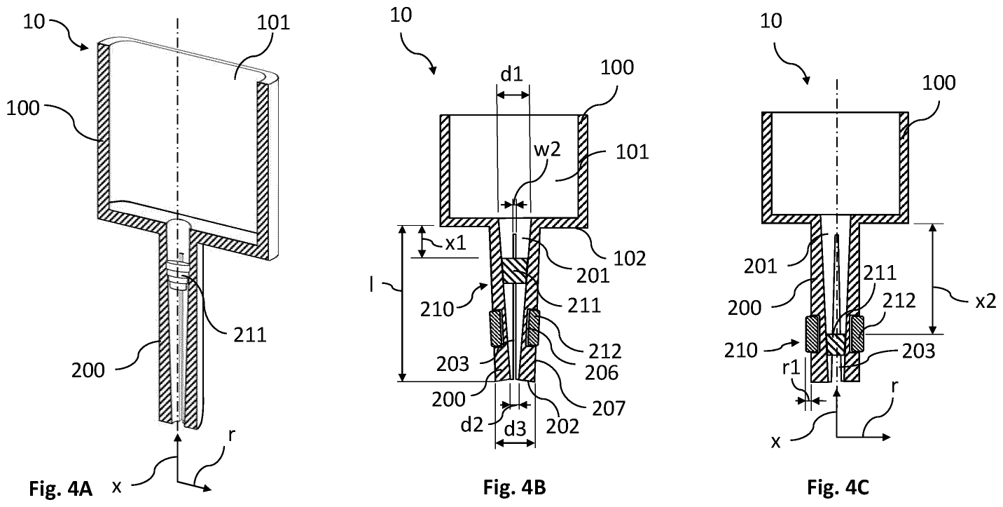

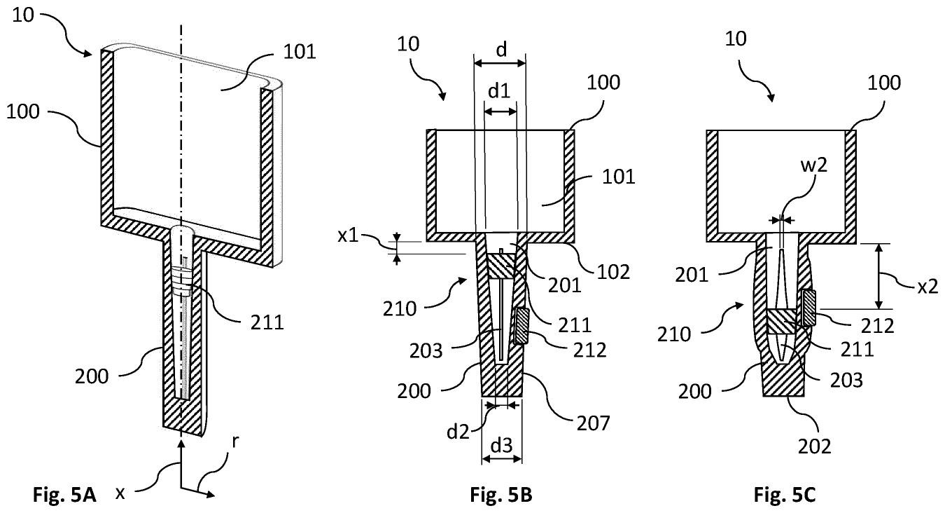

FIGS. 4A to 4C and 5A to 5C are schematic views of the connector 10 according to a second and a third embodiment, which can be combined with any of the features as described above. The connector portion 200 comprises a conical shape over the length 1, extending from diameter d proximate the body portion 100 to a diameter d3 at an end face 202 of the connector portion 200. Diameter d proximate to the body portion 100 is larger than the diameter d3 at the end face 202 of the connector portion. The connector portion 200 comprises an opening 201 extending from the body portion 100 at least partially in the direction of the longitudinal axis x towards an end face 202 of the connector portion 200 (see, e.g., FIGS. 5A to 5C). However, it should be noted that FIGS. 4A to 4C show an embodiment, wherein the opening 201 extends over the full length 1 of the connector portion 200 between body portion 100 and end face 202. The opening 201 comprises a conical shape having a diameter d1 at the body portion 100 and a diameter d2 proximate the end face 202, wherein d1>d2. The body portion 100 comprises a body portion cavity 101 and the opening 201 opens into the body portion cavity 101. In other words, the opening 201 extends into the body portion cavity 101. The body portion cavity 101 extends from a second body end face, more specifically a front end face, of the body portion 100 in the direction of the longitudinal axis towards the connector portion 200. The second body end face is opposite the first body portion end face 102 from which the connector portion 200 extends.

The expanding and/or contracting mechanism 210 comprises a dilator component 211 which is configured to be inserted into the opening 201. The dilator component 211 can be inserted into the opening 201 through the body portion cavity 101. As shown in FIG. 4B, the dilator component 211 can have a conical shape, whereby an insertion of the dilator component 211 into the opening 201 can be simplified. The expanding and/or contracting mechanism 210 is formed by the connector portion 200 and the dilator component 211. The expanding and/or contracting mechanism 210 may be in an expanded state when the dilator component 211 is inserted into the opening 201 and/or is proximate the end face 202. The expanding and/or contracting mechanism 211 may be in a contracted state when the dilator component 211 is removed from the opening 201 and/or is proximate the body portion cavity 101. In other words, the extent of expansion in the radial direction r of the expanding and/or contracting mechanism 210 depends on the axial position of the dilator component 211. In embodiments, the expanding and/or contracting mechanism 210 may be in the contracted state when the dilator component 211 is inserted into the opening 201 but is proximate the body portion 100 and/or the body portion cavity 101. In FIGS. 4B, 4C, 5B and 5C, the dilator component 211 is shown in a first position x1 and in a second position x2. First and second positions x1, x2 are defined by distances measured between first body portion end face 102 and dilator component 211 parallel to the longitudinal axis x. When the dilator component 211 is moved from the first position x1 proximate the body portion cavity 101 and/or the body portion 100 towards the end face 202 in the direction of the longitudinal axis x, the expanding and/or contracting mechanism 210 transitions from the contracted state to the expanded state. In the expanded state, the expanding and/or contracting mechanism 210 is expanded in the radial direction r, and in the contracted state, the expanding and/or contracting mechanism 210 is contracted in the radial direction r.

The dilator component 211 can be slidably inserted into the opening 201. In this case the dilator component 211 may be cylindrical, square shaped or rectangular. The opening 201 may have a corresponding cross-section adapted to receive the dilator component 211. In order to maintain the dilator component 211 in position, the connector 10 may comprise a retaining component that is operatively coupled to the dilator component 211. In an embodiment, the retaining component may comprise a movable switch. In a first position of the switch, the dilator component 211 may be removed from the opening 201 or may be proximate the body portion 100 (in the contracted state). In a second position of the switch, the dilator component 211 may be inserted into the opening 201 and/or may be proximate the end face 202 (in the expanded state). In order to move the switch, a user may apply a force which exceeds a retaining force provided by the retaining component. In embodiments, the outer surface of the opening 201 and/or of the dilator component 211 may comprise one or more grooves or ridges, which increase a retaining force between dilator component 211 and opening 201. In examples, the dilator component 211 can be screwed into the opening 201. Thereby, the opening 201 may comprise an internal thread and the dilator component 211 may comprise an external thread. In this case, the dilator component 211 may be cylindrical and screwed into the opening 201 which leads to the advantage that the dilator component 211 remains in position such that a separate retainer component is not necessary. The size and shape of the dilator component 211 may define the radial expansion of the expanding and/or contracting mechanism. Thus, an appropriate dilator component 211 may be selected to expand the connector portion 200 to fit into the desired handle 30.

In embodiments, the retention and/or release mechanism 300 as described above can be at least partially inserted into the body portion cavity 101. The retention and/or release mechanism 300 can be configured to hold the dilator component 211 in position when connected to the body portion 100, more specifically wherein the retention and/or release mechanism 300 is operatively coupled to the retaining component and/or forms the retaining component. In an embodiment, the retention and/or release mechanism 300 can be connected to the body portion 100 by a positively locking connection. Thereby, a button may be provided to decouple the retention and/or release mechanism 300 from the body portion 100 upon activation by a user. Decoupling the retention and/or release mechanism 300 from the body portion 100 may also lead to removing the dilator component 211 (or bringing the dilator component 211 in the proximity of the body portion 100) from the opening 201 such that the expanding and/or contracting mechanism 210 is in a contracted state. Furthermore, the body portion 100 and/or the retention and/or release mechanism 300 may comprise a switch. An operation of the switch may lead to a release of the razor head. If the dilator component 211 is provided as a screw, it may only be possible to screw the dilator component 211 into the opening 201 when the retention and/or release mechanism 300 is decoupled from the body portion 100.

As shown in FIGS. 5A to 5C, the connector portion 200 comprises at least one slot 203 extending along the longitudinal axis x at least partially over the length 1. The at least one slot 203 extends between opening 201 and outer circumferential surface 207 in the radial direction r. FIGS. 4A to 4C show an embodiment, wherein the at least one slot 203 extends along the longitudinal axis x from a position proximate the body portion 100 to the end face 102. In the contracted state, the at least one slot 203 may have a width w2 (see, e.g., FIGS. 4B and 5B). As shown in FIGS. 4B and 5B, the width w2 is constant. In examples, the width w2 may decrease from a position proximate the body portion 100 towards the end face 202. In the expanded state, the width w2 may increase from a position proximate the body portion towards the end face 202 (see, e.g. FIG. 4C). As shown in FIG. 5C, in the expanded state, the at least one slot may have a first section with an increasing width w2 from a position proximate the body portion 100 towards the end face 202, followed by a second section having an approximately constant width w2, more specifically in the area of the dilator component 211, followed by a third section having a decreasing width w2 between the dilator component 211 and towards the end face 202.

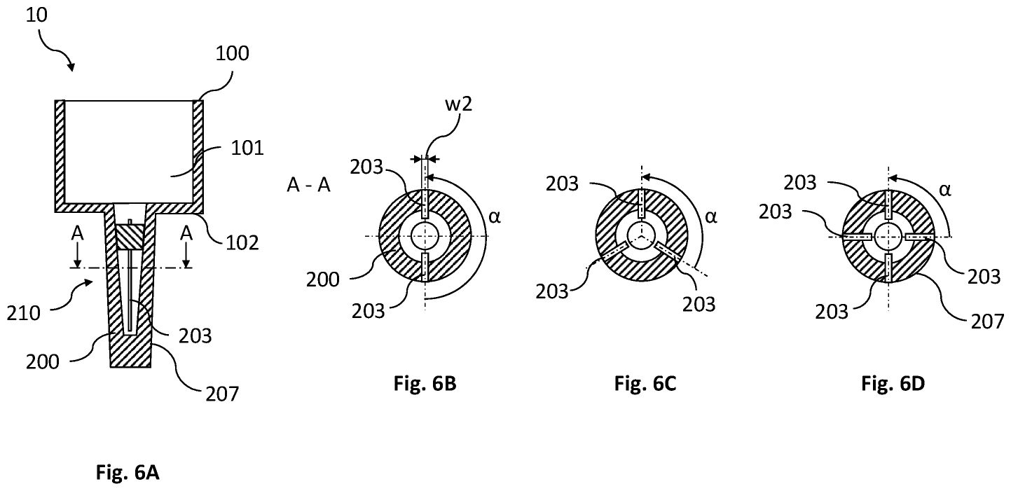

FIGS. 6A to 6D are schematic cutaway views of the connector 10 according to the third embodiment as shown in FIGS. 5A to 5C. In particular, FIGS. 6B to 6D show cross-sections of the connector portion 10 at cut A-A. In an embodiment as shown in FIG. 6B, the connector portion 200 comprises two slots 203 extending along the longitudinal axis x partially over the length 1 between body portion 100 and end face 102. The two slots 203 are separated by an angle α that is measured between the slots 203 on the outer circumferential surface 207, more specifically wherein α=180°. More detailed, the angle α is measured in the circumferential direction of the connector portion 200 with respect to the longitudinal axis x. In another embodiment as shown in FIG. 6C, the connector portion 200 comprises three slots 203 that are separated by an angle of 120° between each of the slots 203, measured in the circumferential direction. In another embodiment as shown in FIG. 6B, the connector portion 200 comprises four slots 203 that are separated to each other by an angle of 90°, measured in the circumferential direction. However, in embodiments, other angles can be chosen between the respective slots 203, wherein the slots 203 can be separated in equal angles or can be arranged in groups in the circumferential direction. In embodiments, also more than four slots may be provided. Although the slots 203 are shown in the Figs. as linearly extending in the longitudinal direction x, it should be noted that the respective slots 203 may have different shapes and/or may have shapes that include a curved shape, a wave shape and/or a spiral shape. Additionally, the width w2 of the respective slots 203 may differ.

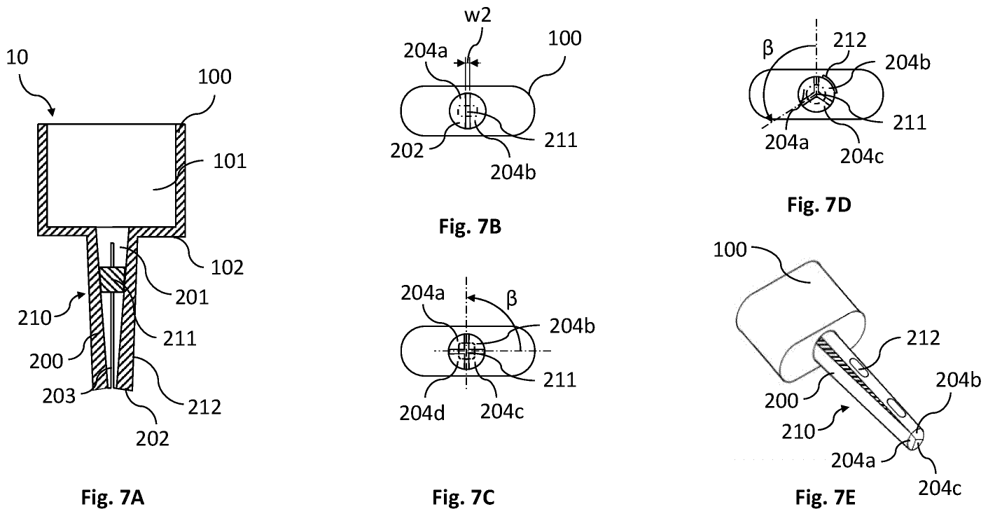

FIGS. 7A to 7E are schematic views and bottom views of the connector 10 according to the second embodiment as shown in FIGS. 4A to 4C. In FIG. 7B, the connector portion 200 comprises at least two segments 204a, 204b extending in the longitudinal direction x. The at least two segments 204a, 204b can be at least partially separated to each other by the at least one slot 203. The at least two segments 204a, 204b may be separate components and may be separated to each other by the at least one slot 203. As described above, the connector portion 200 can comprise a slot (or slots) which extend from a position proximate the body portion 100 to the end face 202. Thus, the slots can extend over the whole length 1 and through the whole diameter d (or width and/or thickness) of the connector portion 200. In the contracted state, the at least one slot 203 may have a width that is substantially constant over the length 1 of the connector portion 200 (see, e.g., FIGS. 4B, 7B). In examples, the width w2 may decrease from a position proximate the body portion 100 towards the end face 202 (see, e.g., FIG. 7E). In the expanded state, the width w2 may increase from a position proximate the body portion 100 towards the end face 202. Thereby, two segments 204a, 204b are provided which together form a two-sided interface. Each segment can extend over a circumferential area of about β=180°. One or more of the segments 204a, 204b can comprise the at least one recess 206 and the at least one elastic component 212 arranged in the recess 206. However, in this case the recess 206 may not extend through the diameter d of the connector portion 200. In the contracted state, the at least two segments 204a, 204b may be adapted to at least partially contact each other (see, e.g., FIG. 7E) and/or wherein in the expanded state, the at least two segments 204a, 204b may be separated to each other by the at least one slot 203. In embodiments, the at least two segments 204a, 204b can be rigidly, more specifically integrally, connected to the body portion 100. If the connector portion 200 comprises a rectangular shape or square shape instead of the cylindrical shape as shown in FIGS. 7A to 7E, the at least two segments 204a, 204b may provide an anti-rotation means when the connector portion 200 is coupled to the razor handle 30. In this case, the razor handle 30 may have a protrusion or shape on the inner surface 32, which, together with the at least two segments 204a, 204b, prevents rotation when coupled.

FIG. 7D shows an embodiment, wherein the connector portion 200 comprises three segments 204a, 204b, 204c. Each segment 204a, 204b, 204c may extend over a circumferential area of about 110°<β<130°. Thus, the three segments 204a, 204b, 204c together form a three-sided interface. In FIG. 7D, the second segment 204b comprises at least one elastic component 212 arranged in a recess 206 provided in the second segment 204b. However, it may also be possible that two or all of the segments 204a, 204b, 204c comprise the at least one recess 206 and the at least one elastic component 212 arranged in the recess 206. As indicated in FIG. 7E, the second segment 204b comprises two recesses 206 and two elastic components 212 arranged in the recesses. More specifically, the recesses 206 and/or elastic components 212 are aligned in the direction of the longitudinal axis x.

FIG. 7C shows an embodiment, wherein the connector portion 200 comprises four segments 204a, 204b, 204c, 204d. Each segment 204a, 204b, 204c, 204d can be arranged over a circumferential area of about 80°<β<100°. Thereby, a four-sided interface can be formed. One or more (two, three or all) of the segments 204a, 204b can comprise the at least one recess 206 and the at least one elastic component 212 arranged in the recess 206.

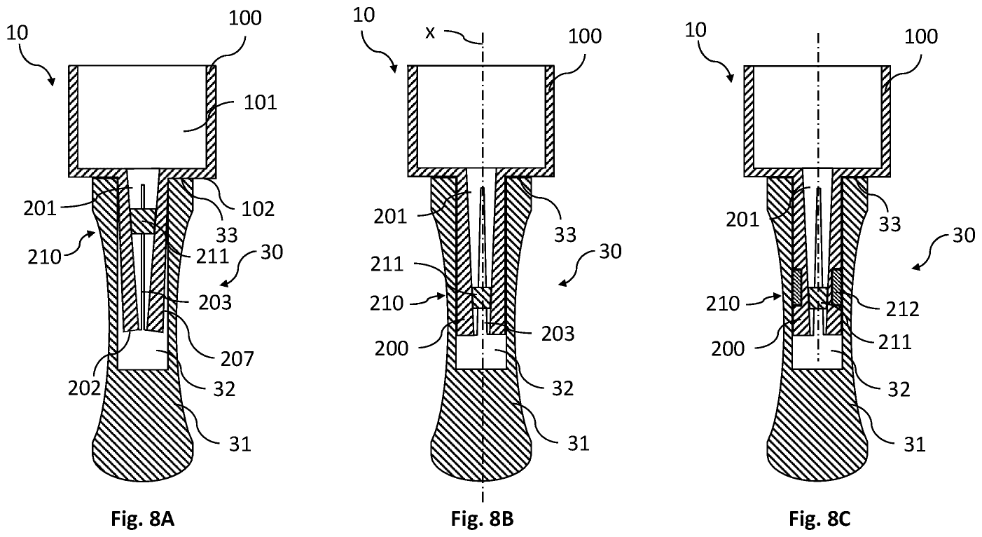

FIGS. 8A to 8C are schematic cutaway side views of the connector 10 coupled to the razor handle 30 according to the second embodiment (the third embodiment may be coupled in the same way). In FIG. 8A, the connector portion 200 is inserted into the cavity of the tubular body portion 31 of the razor handle 30. However, the expanding and/or contracting mechanism 210 is in the contracted state, since the dilator component 211 is proximate the body portion 100. It should be noted that the retention and/or release mechanism 300 is not shown in FIGS. 8A to 8C. When inserted, the first body end face 102 may contact the razor handle end face 33. In the contracted state, the outer circumferential surface 207 may be at least partially separated to the inner surface 32 when the connector portion 200 comprises a conical shape.

In FIG. 8B, the expanded state of the expanding and/or contracting mechanism 210 is shown. In this case, the dilator component 211 is moved in the longitudinal direction x towards the end face 202 which results in an expansion of expanding and/or contracting mechanism 210 in the radial direction r. The outer circumferential surface 207 contacts the inner surface 32 and a force is applied against surfaces 207, 32 in the radial direction r. Due to the non-positively locking, more specifically the friction force that is generated between surfaces 207, 32, the connector 10 is coupled to the razor handle 10. In other words, a press-fit is formed between the connector 10 and the razor handle 30. Due to the conical design of the dilator component 211 and the opening 201, the force in the radial direction r increases the further the dilator component 211 is moved towards the end face 202. In FIG. 8C the connector 10 is coupled to the razor handle 10 as described for the embodiment shown in FIG. 8B. However, the connector portion 200 additionally comprises the at least one recess 206 and the at least one elastic component 212. More specifically, in FIG. 8C, the connector portion 200 comprises two segments wherein each segment comprises a recess 206 and an elastic component 212. In the expanded state, the two elastic components 212 are additionally compressed between the connector portion 200 and the inner surface 32. Thus, a friction force between outer surfaces of the elastic components 212 and the inner surface 32 is increased, resulting in a more stable coupling between connector 10 and razor handle 30.

It should be noted that in embodiments (not shown in the Figs.), the connector portion 200 comprising the expanding and/or contracting mechanism 210 may not form part of the connector 10 but can be integrated in the razor handle 30. Thereby, the razor handle 30 may comprise the connector portion 200 including the expanding and/or contracting mechanism 210 as described above. In this case, the connector 10 may comprise a tubular body portion with a cavity adapted to receive the connector portion 200 and the expanding and/or contracting mechanism 210 provided on the razor handle 30.

In an embodiment, a kit of parts is provided (not shown in the Figs.). The kit of parts comprises a razor head holder comprising a plurality of razor heads 20. Furthermore, the kit of parts comprises a connector 10 as described above. The connector 10 can be coupled to one of the plurality of razor heads 20. In embodiments, the kit of parts can further comprise a razor handle 30. The connector 10 can be coupled to the razor handle 30.

Furthermore, the present disclosure relates to a method of assembling a razor 1. The method comprises providing a razor handle 30 and a connector 10 as described above, inserting the connector portion 200 into the razor 30, and coupling the connector 10 to the razor handle 30 via the connector portion 200 and the expanding and/or contracting mechanism 210. In embodiments, coupling the connector 10 to the razor handle 30 may comprise expanding the expanding and/or contracting mechanism 210 in the radial direction r and applying a force in the radial direction r against an inner surface 32 of a cavity of the razor handle 30. In embodiments, applying the force in the radial direction r may be achieved by the at least one elastic component 212 and/or by the dilator component 211 when inserted into the opening 201 and moved towards the end face 102. In an embodiment, the method can further comprise providing a razor head 20 and coupling the connector 10 to the razor head 20. In an embodiment wherein the dilator component 211 is provided, coupling the connector 10 to the razor head 20 may comprise connecting the retention and/or release mechanism 300 to the body portion 100, thereby inserting the dilator component 211 into the opening 201, and connecting the razor head to the retention and/or release mechanism 300.

Although the present invention has been described above and is defined in the attached claims, it should be understood that the invention may be defined in accordance with the following embodiments:
1. A connector (10) for connecting a razor head (20) to a razor handle (30), comprising:
   a body portion (100); and
   a connector portion (200) extending from the body portion (100), wherein the connector portion (200) is configured to be coupled to the razor handle (30); characterized in that the connector portion (200) comprises an expanding and/or contracting mechanism (210).
2. The connector (10) according to embodiment 1, wherein the expanding and/or contracting mechanism (210) is configured to couple the connector (10) to the razor handle (30) by a non-positively locking connection, more specifically by a friction-locking connection.
3. The connector (10) according to embodiment 1 or embodiment 2, wherein the connector (10) comprises a longitudinal axis (x), wherein the expanding and/or contracting mechanism (210) is adapted to expand and/or contract in a radial direction (r) perpendicular to the longitudinal axis (x).
4. The connector (10) according to any one of the preceding embodiments, wherein the connector portion (200) comprises a length (l), a diameter (d) and an outer circumferential surface (207).
5. The connector (10) according to embodiment 4, wherein the length (l) is between 10 mm to 70 mm, more specifically between 15 mm to 60 mm, in particular between 20 mm to 50 mm.
6. The connector (10) according to embodiment 4 or embodiment 5, wherein the diameter (d) is between 0.5 mm to 20 mm, more specifically between 3 mm to 15 mm, in particular between 5 mm to 12 mm.
7 The connector (10) according to any one of embodiments 4 to 6, wherein the connector portion (200) comprises a conical shape over the length (l), extending from diameter (d) proximate the body portion (100) to a diameter (d3) at an end face (202) of the connector portion (200).
8. The connector (10) according to embodiment 7, wherein the diameter (d) proximate to the body portion (100) is larger than the diameter (d3) at the end face (202) of the connector portion.
9. The connector (10) according to any one of the preceding embodiments, wherein the connector portion (200) comprises at least one recess (206).
10. The connector (10) according to embodiment 9, wherein the at least one recess (206) comprises a longitudinal shape extending substantially in the direction of the longitudinal axis (x).
11. The connector (10) according to any one of the preceding embodiments, wherein the expanding and/or contracting mechanism (210) comprises at least one elastic component (212), more specifically an elastic friction component (212).
12. The connector (10) according to embodiment 11, when dependent on claim 9, wherein the at least one elastic component (212) is arranged in the at least one recess (206).
13. The connector (10) according to embodiment 11, wherein the at least one elastic component (212) is provided as sleeve that is disposed about the connector portion (200).
14. The connector (10) according to any one of embodiments 11 to 13, wherein the at least one elastic component (212) is configured to expand and/or contract in the radial direction (r).
15. The connector (10) according to any one of embodiments 11 to 14, wherein the at least one elastic component (212) comprises a polymeric material, more specifically wherein the at least one elastic component (212) comprises a shore hardness of 10 A to 60 A, in particular of 20 A to 50 A.
16. The connector (10) according to any one of embodiments 12, 14 or 15, wherein the at least one elastic component (212), when inserted into the at least one recess (206), extends in the radial direction (r) beyond the outer circumferential surface (207) by a distance (r1) of at least 0.05 mm, more specifically by at least 0.10 mm, in particular by at least 0.30 mm.
17. The connector (10) according to any one of embodiments 11, 12, 14, 15 or 16, wherein the at least one elastic component (212) comprises a length (l1) and a width (w1), more specifically wherein the at least one elastic component (212) comprises an upper face (213) and a lower face (214), wherein the upper face (213) and/or the lower face (214) has the length (l1) and the width (w1).
18. The connector (10) according to embodiment 17, wherein the length (l1) is between 1 mm to 20 mm, more specifically between 2 mm to 15 mm.
19. The connector (10) according to embodiment 17 or embodiment 18, wherein the width (w1) is between 0.2 mm to 15 mm, more specifically between 1 mm to 10 mm.
20. The connector (10) according to any one of embodiments 9 to 19, wherein the connector portion (200) comprises a first recess (206a) and a second recess (206b), more specifically wherein the first recess (206a) and the second recess (206b) are aligned to each other on the outer circumferential surface (207) in the direction of the longitudinal axis (x).
21. The connector (10) according to embodiment 20, wherein the expanding and/or contracting mechanism (210) comprises a first elastic component (212a) and a second elastic component (212b), wherein the first elastic component (212a) is arranged in the first recess (206a) and wherein the second elastic component (212b) is arranged in the second recess (206b).
22. The connector (10) according to any one of embodiments 9 to 21, wherein the at least one recess (206) extends in the radial direction (r) through the whole diameter (d) of the connector portion (200).
23. The connector (10) according to embodiment 22, wherein the at least one elastic component (212) comprises a diameter (d4) that is larger than the diameter (d) of the connector portion (200), more specifically wherein the diameter (d4) is at least 1.1 times larger than the diameter (d), in particular wherein the diameter (d4) is at least 1.2 times larger than the diameter (d).
24. The connector (10) according to embodiment 22 or embodiment 23, wherein the at least one elastic component (212) has a cross-section that tapers from the upper face (213) and/or lower face (214) towards a geometric center of the at least one elastic component (212), more specifically wherein the at least one elastic component (212) tapers at an angle (γ) of from 90°<γ<135°, more specifically of from 105°<γ<120°, measured between the upper face (213) and/or the lower face (214) and the taper of the at least one elastic element (212).
25. The connector (10) according to any one of embodiments 22 to 24, wherein the at least one recess (206) comprises a complementary shape with respect to the shape of the at least one elastic component (212), more specifically wherein the cross-section of the at least one recess (206) tapers from the outer circumferential surface (207) in the radial direction (r) towards the longitudinal axis (x) on each side.
26. The connector (10) according to any one of the preceding embodiments, wherein the connector portion (200) comprises an opening (201) extending from the body portion (100) at least partially in the direction of the longitudinal axis (x) towards an end face (202) of the connector portion (200).
27. The connector (10) according to claim 23, wherein the opening (201) comprises a conical shape having a diameter (d1) at the body portion and a diameter (d2) proximate the end face (202), wherein d1>d2.
28. The connector (10) according to embodiment 26 or embodiment 27, wherein the body portion (100) comprises a body portion cavity (101) and wherein the opening (201) opens into the body portion cavity (101).
29. The connector (10) according to embodiment 28, wherein the expanding and/or contracting mechanism (210) comprises a dilator component (211) which is configured to be inserted into the opening (201), more specifically wherein the dilator component (211) is inserted into the opening (201) through the body portion cavity (101).
30. The connector (10) according to embodiment 29, wherein the dilator component (211) is slidably inserted into the opening (201).
31. The connector (10) according to embodiment 29, wherein the dilator component (211) is screwed into the opening (201), more specifically wherein the opening (201) comprises an internal thread and wherein the dilator component (211) comprises an external thread.
32. The connector (10) according to any one of embodiments 29 to 31, wherein the expanding and/or contracting mechanism (210) is formed by the connector portion (200) and the dilator component (211), wherein the expanding and/or contracting mechanism (210) is in an expanded state when the dilator component (211) is inserted into the opening (201) and/or is proximate the end face (202), and/or, wherein the expanding and/or contracting mechanism (211) is in a contracted state when the dilator component (211) is removed from the opening (201) and/or is proximate the body portion cavity (101).
33. The connector (10) according to embodiment 32, wherein in the expanded state, the expanding and/or contracting mechanism (210) is expanded in the radial direction (r), and wherein in the contracted state, the expanding and/or contracting mechanism (210) is contracted in the radial direction (r).
34. The connector (10) according to any one of the preceding embodiments, wherein the connector portion (200) comprises at least one slot (203) extending along the longitudinal axis (x) at least partially over the length (l), more specifically wherein the at least one slot (203) extends between opening (201) and outer circumferential surface (207) in the radial direction (r).
35. The connector (10) according to embodiment 34, wherein the connector portion (200) comprises two slots (203) extending along the longitudinal axis (x) at least partially over the length (l), wherein the two slots (203) are separated by an angle (a) that is measured between the slots (203) on the outer circumferential surface (207), more specifically wherein α=180°.
36. The connector (10) according to any one of embodiments 3 to 35, wherein the connector portion (200) comprises at least two segments (204a, 204b) extending in the longitudinal direction (x), more specifically wherein the at least two segments (204a, 204b) are at least partially separated to each other by at least one slot (203).
37. The connector (10) according to embodiment 36, wherein the connector portion (200) comprises three segments (204a, 204b, 204c), more specifically wherein each segment (204a, 204b, 204c) extends over a circumferential area of about 110°<β<130°.
38. The connector (10) according to embodiment 36, wherein the connector portion (200) comprises four segments (204a, 204b, 204c, 204d), more specifically wherein each segment (204a, 204b, 204c, 204d) is arranged over a circumferential area of about 80° <β<100°.
39. The connector (10) according to any one of embodiments 36 to 38, wherein in the contracted state, the at least two segments (204a, 204b) are adapted to at least partially contact each other and/or wherein in the expanded state, the at least two segments (204a, 204b) are separated to each other by the at least one slot (203).
40. The connector (10) according to any one of the preceding embodiments, further comprising a retention and/or release mechanism (300) connected to the body portion (100), which is configured to be coupled to a razor head (20), more specifically wherein the retention and/or release mechanism (300) is connected to the body portion (100) on a side opposite the connector portion (200).
41. The connector (10) according to embodiment 40, wherein the retention and/or release mechanism (300) is integrally connected to the body portion (100), or, wherein the retention and/or release mechanism (300) is formed as a separate component and connectable to the body portion (100) by a positively locking and/or non-positively locking connection.
42. The connector (10) according to any one of the preceding embodiments, wherein the connector (10) is manufactured by die-casting and/or moulding, and/or wherein the at least one elastic component (212) is manufactured by casting and/or injection molding.
43. A kit of parts, comprising:
   a razor head holder comprising a plurality of razor heads (20); and
a connector (10) according to any one of the preceding embodiments.
44. The kit of parts according to embodiment 43, further comprising a razor handle (30).

45. A razor (1), comprising:
a razor handle (30);
a razor head (20); and
a connector (10) according to any one of embodiments 1 to 42, wherein the connector (10) is coupled to the razor handle (30) and/or to the razor head (20).
46. The razor (1) according to embodiment 45, wherein the razor handle (30) comprises a tubular body portion (31) having a cavity with an inner surface (32), an inner diameter (d5) and a length (l2), wherein the connector portion (200) is inserted into the tubular body portion (31).
47. The razor (1) according to embodiment 45 or embodiment 46, wherein the expanding and/or contracting mechanism (210) applies a force in the radial direction (r) against the inner surface (32) of the tubular body portion (31), more specifically wherein the connector portion (200) is coupled to the razor handle (30) by a non-positively locking connection, in particular by a press-fit connection.
48. The razor (1) according to embodiment 47, wherein the expanding and/or contracting mechanism (210) applies a force of at least 0.5 N, more specifically of at least 3 N, in particular of at least 5 N in the radial direction (r).
49. A method of assembling a razor (1), comprising:
   providing a razor handle (30);
   providing a connector (10) as claimed in any one of embodiments 1 to 42,
   inserting the connector portion (200) into the razor handle (30), and coupling the connector (10) to the razor handle (30) via the connector portion (200) and the expanding and/or contracting mechanism (210).
50. The method according to embodiment 49, wherein coupling the connector (10) to the razor handle (30) comprises expanding the expanding and/or contracting mechanism (210) in the radial direction (r) and applying a force in the radial direction (r) against an inner surface (32) of a cavity of the razor handle (30).
51. The method according to embodiment 49 or embodiment 50, further providing a razor head (20), and coupling the connector (10) to the razor head (20).

REFERENCE NUMERALS

| | | | |
|---|---|---|---|
| 1 | razor | x | longitudinal axis/direction |
| 10 | connector | x1 | first position of dilator component |
| 20 | razor head | | (contracted state) |
| 30 | razor handle | x2 | second position of dilator component |
| 31 | tubular body portion | | (expanded state) |
| 32 | inner surface of cavity of razor handle | r | radial direction |
| 100 | connector body | d | diameter of the connector portion |
| 101 | body portion cavity | d1 | inner diameter of opening proximate |
| 102 | first body end face | | the body portion |
| 200 | connector portion | d2 | inner diameter of opening proximate |
| 201 | opening | | the end face |
| 202 | end face of connector portion | d3 | diameter of the connector portion at |
| 203 | slot | | the end face |
| 204a | first segment | d4 | diameter/thickness of the elastic |
| 204b | second segment | | component |
| 204c | third segment | d5 | inner diameter of tubular handle |
| 204d | fourth segment | | portion |
| 206 | recess | l | length of connector portion |
| 206a | first recess | l1 | length of the elastic component |
| 206b | second recess | l2 | length of cavity of tubular body |
| 207 | outer circumferential surface | | portion |
| 210 | expanding and/or contracting | r1 | distance beyond circumferential |
| | mechanism | | surface |
| 211 | dilator component | w1 | width of the elastic component |
| 212 | elastic component | w2 | width of slot |
| 212a | first elastic component | γ | taper angle of the elastic component |
| 212b | second elastic component | δ | taper angle of the recess(es) |
| 213 | upper face | α | angle between slots |
| 214 | lower face | β | angle of circumferential area of a |
| 300 | retention and/or release mechanism | | segment |

1. A connector for connecting a razor head to a razor handle, comprising:
a body portion; and
a connector portion extending from the body portion, wherein the connector portion is configured to be coupled to the razor handle;
wherein the connector portion comprises an expanding and/or contracting mechanism configured to couple the connector to the razor handle by a non-positively locking connection.

2. The connector according to claim 1, wherein the expanding and/or contracting mechanism is configured to couple the connector to the razor handle by a friction-locking connection.

3. The connector according to claim 1, wherein the connector portion comprises at least one recess.

4. The connector according to claim 1, wherein the expanding and/or contracting mechanism comprises at least one elastic component, more specifically an elastic friction component, in particular wherein the at least one elastic component is configured to expand and/or contract in the radial direction (r).

5. The connector according to claim 4, wherein the at least one elastic component extends in the radial direction beyond an outer circumferential surface of the connector portion by a distance of at least 0.05 mm, more specifically by at least 0.10 mm, in particular by at least 0.30 mm.

6. The connector according to claim 3, wherein the connector portion comprises a diameter, and wherein the at least one recess extends in the radial direction through the whole diameter of the connector portion.

7. The connector according to claim 1, wherein the connector portion comprises an opening extending from the body portion at least partially in the direction of the longitudinal axis (x) towards an end face.

8. The connector according to claim 7, wherein the expanding and/or contracting mechanism comprises a dilator component which is configured to be inserted into the opening.

9. The connector according to claim 8, wherein the expanding and/or contracting mechanism is formed by the connector portion and the dilator component, wherein the expanding and/or contracting mechanism is in an expanded state when the dilator component is inserted into the opening and/or is proximate the end face and/or, wherein the expanding and/or contracting mechanism is in a contracted state when the dilator component is removed from the opening and/or is proximate the body portion cavity, more specifically wherein, in the expanded state, the expanding and/or contracting mechanism is expanded in the radial direction, and wherein, in the contracted state, the expanding and/or contracting mechanism is contracted in the radial direction.

10. The connector according to claim 7, wherein the connector portion comprises at least one slot extending along the longitudinal axis at least partially over a length of the connector portion, more specifically wherein the at least one slot extends between opening and outer circumferential surface in the radial direction.

11. The connector according to claim 2, wherein the connector portion comprises at least two segments extending in the longitudinal direction, more specifically wherein the at least two segments are at least partially separated to each other by at least one slot, in particular wherein in the contracted state, the at least two segments are adapted to at least partially contact each other and/or wherein in the expanded state, the at least two segments are separated to each other by the at least one slot.

12. A kit of parts, comprising:
a razor head holder comprising a plurality of razor heads; and
a connector according to claim 1.

13. A razor, comprising:
a razor handle;
a razor head; and
a connector according to claim 1, wherein the connector is coupled to the razor handle and/or to the razor head.

14. The razor according to claim 13, wherein the razor handle comprises a tubular body portion having a cavity with an inner surface, wherein the expanding and/or contracting mechanism applies a force in the radial direction against the inner surface of the tubular body portion, more specifically wherein the connector portion is coupled to the razor handle by a press-fit connection.

15. A method of assembling a razor, comprising:
providing a razor handle;
providing a connector as claimed in claim 1,
inserting the connector portion into the razor handle, and
coupling the connector to the razor handle via the connector portion and the expanding and/or contracting mechanism.

16. The connector according to claim 2, wherein the connector comprises a longitudinal axis and the expanding and/or contracting mechanism is adapted to expand and/or contract in a radial direction perpendicular to the longitudinal axis.

17. The connector according to claim 3, wherein the at least one recess comprises a longitudinal shape extending substantially in the direction of the longitudinal axis.

18. The connector according to claim 7, wherein the body portion comprises a body portion cavity and wherein the opening opens into the body portion cavity.

19. The connector according to claim 8, wherein the dilator component is inserted into the opening through a body portion cavity, in particular wherein the dilator component is slidably inserted into the opening, or, wherein the dilator component is screwed into the opening, wherein the opening comprises an internal thread and wherein the dilator component comprises an external thread.

20. The connector according to claim 11, wherein the at least two segments are at least partially separated to each other by at least one slot, in particular wherein in the contracted state, the at least two segments are adapted to at least partially contact each other and/or wherein in the expanded state, the at least two segments are separated to each other by the at least one slot.
